(19) United States
(12) Patent Application Publication
(10) Pub. No.: US 2010/0060121 A1
(43) Pub. Date: Mar. 11, 2010

(54) MODULAR STORAGE UNIT FOR A CABINET

(75) Inventors: John Helgesen, Rock Hill, SC (US); Austin E. Unsworth, Fort Mill, SC (US); Marcel Hohl, Charlotte, NC (US); Edward J. Boteilho, Charlotte, NC (US)

Correspondence Address: TRASKBRITT, P.C., P.O. BOX 2550, SALT LAKE CITY, UT, 84110, US

(73) Assignee: DENTAL EQUIPMENT, LLC DBA PELTON & CRANE, Charlotte, NC (US)

(21) Appl. No.: 12/208,250

(22) Filed: Sep. 10, 2008

(51) Int. Cl. A47B 88/06; B23P 11/00

(52) U.S. Cl. 312/322; 29/428

(57) ABSTRACT

A modular storage unit for a cabinet or other support structure comprising a support structure and a storage unit movably coupled to a lateral portion of the support structure. The support structure may include a cavity with an opening thereto, the size of the cavity being sufficient to receive at least a portion of the storage unit. The storage unit may be slidably coupled to the support structure via a base member and may be rotatably coupled thereto. The storage unit may be independently rotatable about a vertical axis.

### FIELD OF INVENTION

The present invention relates to a storage unit associated with a support structure, a storage unit capable of rotating and pivoting, and more particularly, to a cabinet or cabinet frame having at least one storage unit capable of independent rotation.

### BACKGROUND OF RELATED ART

In some cases, the configuration, structure, and/or orientation of a storage unit(s) are largely determined based upon aesthetic principles, such as color, shape, size. For example, the selection of a storage unit, such as a cabinet, drawer, desk, or shelf, may be largely dependent on the storage unit's aesthetic appeal or appearance.

In other cases, storage units may be configured, designed, and/or structured to serve one or more functions that suit needs or problems particular to an industry or environment. For example, a storage unit may be constructed to a particular size or shape to facilitate an anticipated item or plurality of items that would be stored therein. Additionally, an anticipated environment may affect the configuration of a storage unit. A storage unit, such as a cabinet, may vary depending on where it is built or where the cabinet might be used. Health care facilities, such as medical and dental offices, include examination rooms that typically include a wide array of storage units that were constructed and/or manufacture to suit one or more needs of their anticipated environment.

Unfortunately, once a storage unit, such as a cabinet, desk, or shelf is manufactured or built, modifying and adapting the orientation of the cabinet or desk, or components thereof, can be difficult, labor intensive, and complicated.

Accordingly, there is a need for a modular storage unit that can rotate independently of its support structure and that may readily and easily position a storage unit in a multitude of desired positions and orientations.

### BRIEF SUMMARY OF THE INVENTION

A particular embodiment of the invention includes a modular storage unit comprising a base member movably coupled to a support structure and a storage unit rotatably coupled to the base member. The base member may be slidably coupled to the support structure. Additionally, the storage unit may be independently rotatable about a vertical axis. The modular storage unit may further comprise one or more detents configured to resist and/or prevent motion of the modular storage unit.

In another embodiment of the invention, the modular storage unit may comprise a cabinet. The cabinet may comprise a frame and at least one storage unit movably coupled to a lateral portion of the frame. The lateral portion of the frame may include a cavity or recessed portion. The size of the cavity, or recessed portion, may be sufficient to receive a portion of the at least one storage unit.

In yet another embodiment of the invention, there may be a method of manufacturing a modular storage unit for a cabinet. The method may comprise: providing a cabinet, the cabinet including a frame, and movably coupling at least one storage unit to a lateral portion of the frame. Additionally, the method may comprise providing the lateral portion of the frame with a cavity and an opening thereto. The size of the cavity may be sufficient to receive a portion of the at least one storage unit.

Other features and advantages of the present invention will become apparent to those in the art through consideration of the ensuing description, the accompanying drawings, and the appended claims.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIGS. 1-4 are perspective views of particular embodiments of a modular storage unit that incorporate teachings of the present invention; and

FIG. 5 is an exploded perspective view of a particular embodiment of a modular storage unit that incorporates teachings of the present invention.

### DETAILED DESCRIPTION

Although the foregoing description contains many specifics, these should not be construed as limiting the scope of the present invention, but merely as providing illustrations of some representative embodiments. Similarly, other embodiments of the invention may be devised that do not depart from the spirit or scope of the present invention. Features from different embodiments may be employed in combination.

Reference will now be made to the drawings. Like elements are identified by like numerals. The drawings are not necessarily to scale.

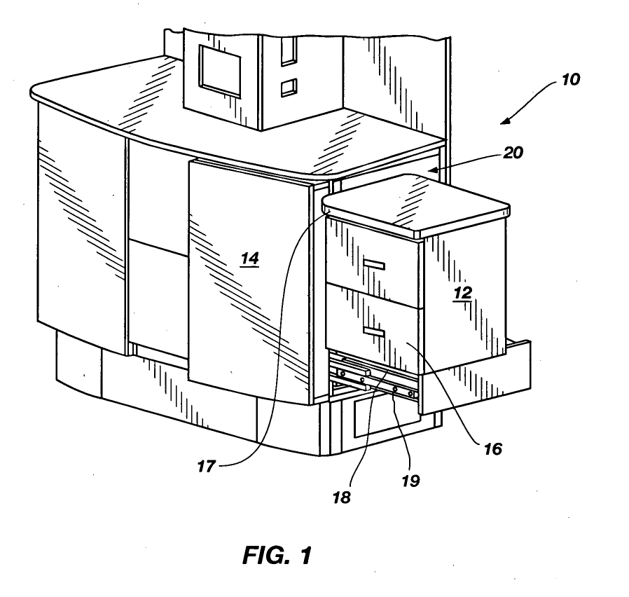

Referring to FIG. 1, a modular storage unit 10 is shown comprising a storage unit 12 movably coupled to a support structure 14. The support structure 14 may be a wall, a frame, a desk, or other type of supporting structure. For example, as shown in FIG. 1, the support structure 14 may be embodied in a cabinet or a cabinet frame.

The storage unit 12 may be any type and/or kind of storage unit configured to store at least one item within the storage unit 12. The storage unit 12 may comprise a first side 16. The first side 16 may include at least one opening, the opening providing access to the interior of the storage unit 12. A top portion of the storage unit 12 may include a solid surface 17 configured to enable additional storage space thereon. It is contemplated that the storage unit 12 may be embodied in a drawer, a set or plurality of drawers, one or more cabinets, shelves, and/or so forth. Additionally, the storage unit 12 may be suited to server a particular interest or necessity including, but not limited to, temperature control, size, shape, and/or so forth.

Shown in FIGS. 1-5, the modular storage unit 10 comprises a storage unit 12 movably coupled to the support structure 14. The storage unit 12 may be coupled to the support structure 14 via a base member 18. It is contemplated the base member 18 may vary in shape, size, and/or configuration. As illustrated, the base member 18 may comprise a substantially planar member disposed substantially underneath the storage unit 12. In being disposed substantially underneath the storage unit 12, it is contemplated that the base member 18, or a portion thereof, may be disposed underneath the storage unit 12.

In one embodiment, the base member 18 may comprise a top surface and a bottom surface, the top surface coupled to a portion of the storage unit 12 and the bottom surface coupled to a first slidable coupling device 19, such as a drawer slide, glide, rail, or any other suitable slidable coupling device. A wide variety of suitable slidable coupling devices are commercially available through manufacturers such as Fulterer USA® of Ontario, Calif. and High Point, N.C.

In an additional embodiment, the first slidable coupling device 19 may comprise a heavy duty, or high-weight capacity slidable coupling device. The heavy duty or high-weight capacity slidable coupling device may allow for heavier equipment and/or other items to be stored in the storage unit 12, or alternatively, disposed on the top portion of the storage unit 12. Additionally, the heavy duty and/or high weight capacity slidable coupling device may enable the top portion of the storage unit to server as a sitting area.

Illustrated in FIGS. 1, 3, 4, and 5, the base member 18 is slidably coupled to, or slidably engaged with the support structure 14. The base member 18 may be slidably coupled to the support structure 14 in any manner contemplated in the art. In a non-limiting example, as shown, the base member 18 may be slidably mounted to the support structure 14 via a drawer slide 19. The drawer slide 19 may enable a user to easily move and/or orient the base member in accordance with his or her particular needs or desires. In alternative embodiments, the base member 18 may be retractably or pivotally coupled to the support structure 14 through the use of collapsible or accordion-type hinges or similar devices.

Illustrated in FIGS. 1-5, the support structure 14 includes a cavity 20 with an opening thereto. The size or area of the cavity 20 may be sufficient to receive a portion of the storage unit 12 and/or base member 18. In one embodiment, the base member 18 may be slidably coupled to an interior portion of the cavity 20, thus enabling the storage unit 12 and base member 18 to slide into the cavity 20 and stored therein. In an additional embodiment, as shown, the size of the cavity 20 may be sufficient to receive the entire storage unit 12, thereby allowing a user to retract the entire storage unit 12 into the support structure 14. In this manner, the modular storage unit 10 provides additional storage space without comprising free space in a room or office.

Also illustrated in FIGS. 1-5, the storage unit 12 may is rotatably coupled to the base member 18 such that the storage unit 12 is able to rotate about a vertical axis. The storage unit 12 may be rotatably coupled to the base member 18 via a rotatable coupling device 54, or rotatably coupling device 54. It is contemplated that any type and/or kind of rotatable coupling device may be used, such as, but not limited to, a ball bearing 54. Some non-limiting examples of ball bearings that may be used include: rotary axial ball bearings, rotary axial roller bearings, angular contact bearings, and deep grove ball bearings.

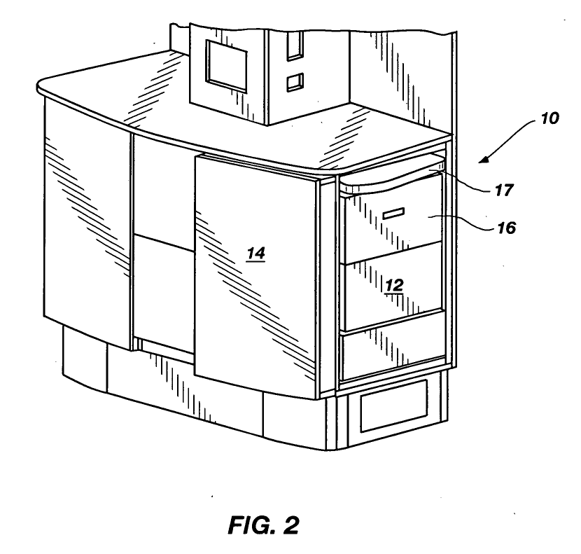

In a particular embodiment, illustrated in FIG. 2, the rotatability of the storage unit 12 allows for an orientation of the storage unit 12 wherein the first side 16 of the storage unit 12 is accessible through the opening of the cavity 20. This enables access to needed or desired items in the storage unit 12, even with the storage unit 12 disposed or retracted in the interior of the cavity 20.

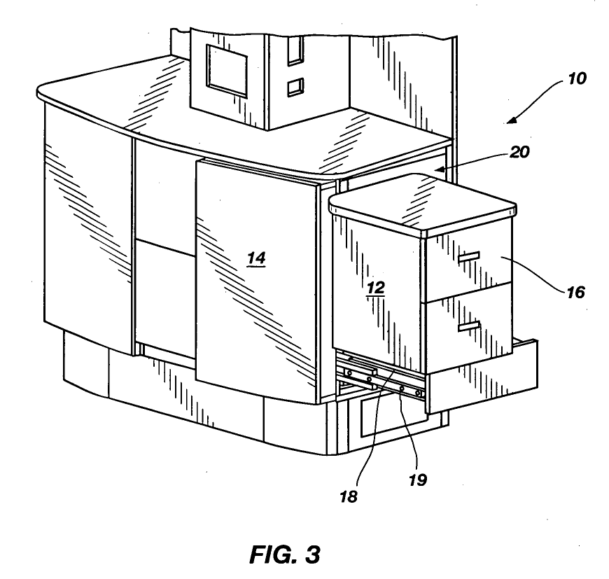

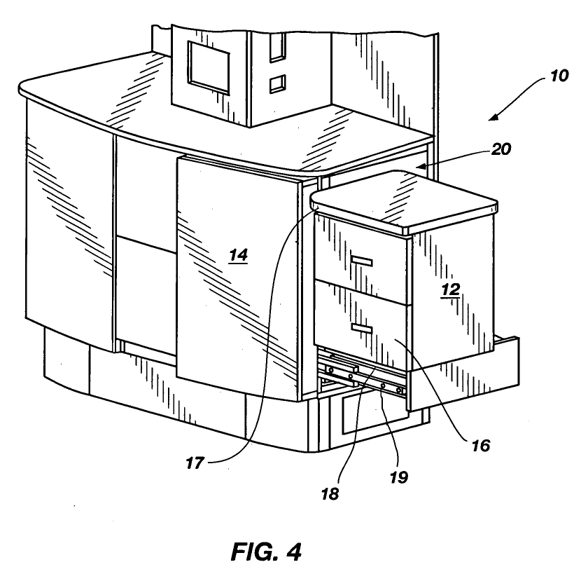

Referring to FIG. 4, the storage unit 12 may be rotatably coupled to the base member 18 in an off-center position. The portion of the base member 18 to which the storage unit 12 is rotatably coupled may vary and/or depend on the needs or desires of a user or environment. As shown, the rotatable coupling device 54 may be disposed off-center on a portion of the base member 18 more proximate to a front portion of the support structure 14 or cabinet. Illustrated in FIG. 3, rotatably coupling the storage unit 12 to the base member 18 off-center causes the storage unit 12, upon rotation, to become misaligned with the cavity 20 and the opening such that the first side 16 of the storage unit 12 overlaps the edge of the base member once it has been rotated, as shown in FIG. 1. This misalignment advantageously assists in preventing the storage unit 12 from retracting and/or sliding into the cavity 20.

In an additional embodiment, rotatably coupling the storage unit 12 in an off-center position provides the modular storage unit 10 with ergonomic advantages. In a non-limiting example, the off-center rotation of the storage unit 12 may cause the first side 16 to extend more proximate to and/or become substantially coextensive with the front portion of the support structure or cabinet, thus, placing the storage unit 12 closer to the reach of users, such as health professionals and assistants. Additionally, being substantially coextensive with the front portion of the support structure or cabinet may prevent a user from being required to reach around a lateral portion of the cabinet to access the storage unit 12.

In yet another embodiment illustrated in FIGS. 2 and 4, the storage unit 12 and/or top portion thereof may comprise at least one protrusion 17 and/or elongated portion 17 extending outward therefrom. The at least one protrusion 17 may be configured to prevent the storage unit 12 from retracting and/or sliding into the cavity 20. As shown, the at least one protrusion 17 may be disposed on the first side 16, thus, upon rotation of the storage unit 12, the at least one protrusion 17 contacts or is coextensive with the cabinet 14.

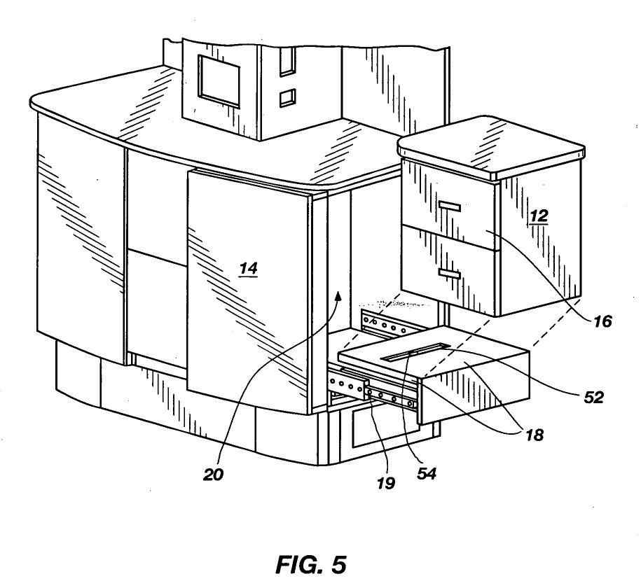

In another alternative embodiment, illustrated in FIG. 5, a second slidable coupling device 52 may be configured to align the storage unit 12 with the cavity 20, thereby preventing the storage unit 12 from retracting and/or sliding into the cavity 20. The modular storage unit 10 may comprise a second slidable coupling device 52 configured to slidably couple the storage unit 12 to the base member 18. The second slidable coupling device 52 may comprise a ball bearing, guide track, guide wheel, drawer slide, or other element configured to enable the storage unit 12 to move or slide independent of the base member 18. It is contemplated that the second slidable coupling device 52 may be embodied as, or be a part of, the rotatably coupling device 54 or may be independent thereof.

In another embodiment, the second slidable coupling device 52 may be oriented substantially orthogonal to the first slidable coupling device 19 such that the storage unit 12 is able to slide in a substantially horizontal trajectory, the trajectory being substantially orthogonal to the first slidable coupling device 19. The second slidable coupling device 52 provides additional benefits, such as, but not limited to, adding an additional degree of motion and orientability to the modular storage unit 10.

In an additional embodiment, the modular storage unit 10 comprises at least one detent configured to resist and/or prevent motion and/or rotation of the storage unit 12. It is contemplated that the at least one detent may be incorporated into and/or be a part of the first slidable coupling device 19, the rotatable coupling device 54, and/or the second slidable coupling device 52. The one or more detents may include positive or negative configurations and may be configured and/or oriented to suit the needs of a particular user or environment.

In an exemplary embodiment, the rotatable coupling device 54 may comprise one or more detents configured to resist and/or prevent the rotation of the storage unit 12. The one or more detents may be separated, for example, by about ninety (90) degrees, allowing the storage unit 12 to freely rotate approximately ninety (90) degrees. A ninety (90) degree separation may be particularly suitable for the one or more embodiments illustrated in FIGS. 1-4, where the support structure 14 comprises a cabinet and/or cabinet frame with a substantially planar rear portion configured to rest near to or against a wall or other solid surface. In being about or approximately ninety (90) degrees, the angle of separation need not be exactly ninety (90) degrees but approximately thereto. In alternative embodiments, any suitable angle of separation may be selected. For example, the detents may be separated by about seventy-five (75), eighty (80), eighty-five, one hundred (100), one hundred and five (105), or any other desirable angle.

As illustrated in FIGS. 1-4, the support structure 14 comprises a cabinet with at least one storage unit 12 that is movably coupled to a lateral portion of the cabinet and/or cabinet frame 14. The storage unit 12 may be rotatable about a vertical axis. One or more detents may be incorporated into the rotatable coupling device 54 at approximately a ninety (90) degree angle to prevent and/or resist rotation of the storage unit 12 to orientations or positions that obstruct access to the first side 16 and/or interior of the storage unit 12. Such orientations may include orientations that place the first side 16 substantially adjacent to a wall or the cavity 20.

FIGS. 1-5 illustrate a modular storage unit 10 movably coupled to a lateral portion of a support structure 14. In one embodiment, the modular storage unit may comprise at least two degrees of motion. The at least two degrees of motion may be independent of the support structure 14. The at least two degrees of motion enable the storage unit 12 to move, rotate, and/or pivot freely while the support structure 14 remains in a fixed or static position. Thus, the position and orientation of the storage unit 12 may be adjusted to adapt to the needs of a user or environment.

The independent rotation and movement of the storage unit 12 is particularly advantageous in medical, dental, and other health-related offices and examining rooms, as such offices or rooms frequently requiring positioning and repositioning storage units for easy and quick access. In some cases, the health and well being of a patient may depend on how quickly a health care provider can access needed supplies or instruments.

A typical arrangement of an examining room may include, among other things, an examining chair or table. A health professional may typically sit or stand next to the chair or table to examine and/or assist a patient. During this time, a health professional may use a variety of instruments, supplies, and other necessities. More particularly, in a dental setting, these instruments and supplies are generally kept in a cabinet or other structure situated near the head of a patient chair, so as to provide the dentist with easy and near access. Additionally, where an assistant is also involved in the treatment of a patient, the storage unit 12 allows easy access and additional work surfaces (i.e., elongated portion 17) for the assistant.

In one aspect of the present invention, the unique embodiment, taught herein provides additional storage space that can assist in reducing the need for a dental or other health professional to leave a patient to retrieve a needed item or instrument. Additionally, the retractability of the storage unit 12 into the cavity 20 allows for quick and easy storage when not needed.

Although the foregoing description includes many specifics, these should not be construed as limiting the scope of the present invention but, merely, as providing illustrations of some of the presently preferred embodiments. Similarly, other embodiments of the invention may be devised which do not depart from the scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

What is claimed:

1. A modular storage unit comprising:
a base member slidably coupled to a support structure; and
a storage unit rotatably coupled to the base member;
wherein the storage unit is independently rotatable about a vertical axis.

2. The modular storage unit of claim 1, wherein a portion of the base member is disposed substantially underneath the storage unit.

3. The modular storage unit of claim 2, wherein a portion the storage unit is rotatably coupled to the base member.

4. The modular storage unit of claim 3, wherein the portion of the storage unit is rotatably coupled to the base member via a ball bearing.

5. The modular storage unit of claim 4, wherein the ball bearing comprises at least one detent configured to resist rotation of the storage unit.

6. The modular storage unit of claim 1, wherein the support structure comprises a cavity with an opening thereto, the cavity sized to receive a portion of the storage unit.

7. The modular storage unit of claim 6, wherein the cavity size is sufficient to receive the entire storage unit.

8. The modular storage unit of claim 1, wherein the support structure comprises a cabinet.

9. The modular storage unit of claim 1, wherein the storage unit is slidably coupled to the support structure via a drawer slide.

10. A cabinet comprising:
a frame; and
a support structure in contact with the frame;
a base member slidably coupled to a support structure; and
the at least one storage unit being rotatably coupled to the base member;
wherein the storage unit is independently rotatable about a vertical axis.

11. The cabinet of claim 10, wherein the at least one storage unit is movably coupled to the lateral portion of the frame via the base member, the at least one storage unit being coupled to the base member and the base member being movably coupled to the lateral portion of the frame.

12. The cabinet of claim 11, wherein the at least one storage unit is independently rotatable about a vertical axis.

13. The cabinet of claim 12, wherein the at least one storage unit is rotatably coupled to the base member in an off-center position.

14. A modular storage unit having at least two degrees of motion, the modular storage unit comprising:
a base member slidably coupled to a support structure via a first slideable coupling device; and
a storage unit slidably coupled to the base member by a second slideable coupling device;
wherein the storage unit is rotatable independent of the support structure about a vertical axis.

15. The modular storage unit of claim 14, wherein the second slideable coupling device is oriented substantially orthogonal to the first slideable coupling device.

16. A method of manufacturing a modular cabinet, the method comprising:
providing a cabinet; and
movably coupling at least one storage unit to a lateral portion of the cabinet;

17. The method of claim 16, wherein movably coupling at least one storage unit to the frame comprises slidably coupling the at least one storage unit to the frame.

18. The method of claim 16, further comprising providing the frame with a cavity and an opening thereto, wherein the cavity size is sufficient to receive a portion of the storage unit.

19. The method of claim 16, wherein movably coupling the at least one storage unit to a lateral portion of frame comprises:
rotatably coupling the at least one storage unit to a base member; and
movably coupling the base member to the lateral portion of the cabinet.
